(19) United States
(12) Patent Application Publication
(10) Pub. No.: US 2023/0260691 A1
(43) Pub. Date: Aug. 17, 2023

(54) Power Conversion Device

(71) Applicant: Mitsubishi Electric Corporation, Chiyoda-ku, Tokyo (JP)

(72) Inventors: Tomohito FUKUDA, Chiyoda-ku, Tokyo (JP); Takashi KUMAGAI, Chiyoda-ku, Tokyo (JP); Kazuaki FUKUI, Chiyoda-ku, Tokyo (JP)

(73) Assignee: Mitsubishi Electric Corporation, Chiyoda-ku, Tokyo (JP)

(21) Appl. No.: 18/006,207

(22) PCT Filed: Aug. 11, 2021
(86) PCT No.: PCT/JP2021/029607

§ 371 Date: Jan. 20, 2023

(30) Foreign Application Priority Data
Aug. 28, 2020 (JP) 2020-144519

(51) Int. Cl. H01F 27/30; H01F 27/26; H02M 7/00

(52) U.S. Cl. CPC H01F 27/306; H01F 27/263; H02M 7/003

(57) ABSTRACT

A first leg portion is arranged between a second leg portion and a third leg portion. A first conductive member includes a first winding wound around the first leg portion and a second winding connected in series to the first winding and wound around the second leg portion. A second conductive member includes a third winding wound around the first leg portion and a fourth winding connected in series to the third winding and wound around the third leg portion. The first leg portion includes a first core member provided with a plurality of gaps and constituted of core pieces and a plurality of first gap members each made of a non-magnetic body and arranged in respective ones of the plurality of gaps in the first core member. Thus, influence by induction heating of the winding can be lessened and a coil can be reduced in size.

### TECHNICAL FIELD

The present disclosure relates to a power conversion device.

### BACKGROUND ART

There has recently been increasing demand for a smaller size and higher output of a power conversion device. It has generally been known that a higher switching frequency of a semiconductor element included in a power conversion device can lead to lowering in inductance at the time of flow of a normal-mode current, of a reactor included in the power conversion device and to reduction in size. The inductance of the reactor effective for removal of noise and reduction in current ripple at the time of flow of the normal-mode current is referred to as a “normal-mode inductance” below.

In order to obtain a desired normal-mode inductance, in the reactor, a core gap is provided in a core composed of a soft magnetic material.

The normal-mode inductance can be lowered by increasing a core gap length. When the core gap length exceeds a certain core gap length, increase in core gap length does not contribute to lowering in normal-mode inductance. Therefore, disadvantageously, the normal-mode inductance cannot highly accurately be set to a desired value.

Linkage of magnetic fluxes that leak from a core gap with a wound coil causes eddy current loss in the coil. In general, a higher frequency of a current and a longer core gap length cause increase in eddy current loss. Thus, for further reduction in loss in a winding, the winding should be changed to a winding larger in cross-sectional area so as to lower a resistance of the winding. In order to increase the cross-sectional area of the winding, a space in the core where a winding can be wound should also be increased, which results also in increase in size of the core. Thus, both of the core and the coil disadvantageously increase in size.

Furthermore, a higher frequency tends to cause electromagnetic interference (EMI) related common-mode noise to be restricted, and a reactor having an inductance with which the common-mode noise can be removed should be added. The inductance of the reactor effective for removal of noise and lowering in current ripple at the time of flow of a common-mode current is referred to as a “common-mode inductance” below.

Therefore, in general, both of a reactor having a normal-mode inductance and a reactor having a common-mode inductance should be incorporated, and it has been difficult to achieve reduction in size of the power conversion device.

Japanese Patent No. 5790700 (PTL 1) discloses a reactor including both of a normal-mode inductance and a common-mode inductance.

### CITATION LIST

### Patent Literature

PTL 1: Japanese Patent No. 5790700

### SUMMARY OF INVENTION

### Technical Problem

In the reactor described in Japanese Patent No. 5790700, each closed magnetic path is provided with a core gap at one location or two locations. Simply by providing a core gap at one location or two locations, however, higher accuracy of the inductance cannot be achieved.

Even when a long core gap is provided in order to obtain a desired common-mode inductance and a desired normal-mode inductance, the inductances in two modes may not highly accurately be achieved.

Furthermore, when a long core gap is provided, induction heating of a winding caused by leakage fluxes in a core gap portion leads to heating of the winding, and a coil disadvantageously increases in size.

A power conversion device in the present disclosure is provided to solve problems as above, and an object of the present disclosure is to provide a power conversion device incorporating a reactor capable of achieving less influence by induction heating of a winding caused by leakage fluxes in a core gap portion and achieving reduction in size of a coil.

### Solution to Problem

The present disclosure relates to a power conversion device. The power conversion device includes a core, a first conductive member, and a second conductive member. The core includes a first member and a second member arranged at a distance from each other and a first leg portion, a second leg portion, and a third leg portion each connecting the first member and the second member to each other. The first leg portion is arranged between the second leg portion and the third leg portion. The first conductive member includes a first winding wound around the first leg portion and a second winding connected in series to the first winding and wound around the second leg portion. The second conductive member includes a third winding wound around the first leg portion and a fourth winding connected in series to the third winding and wound around the third leg portion. The first leg portion includes a first core member composed of a soft magnetic material and provided with a plurality of gaps and a plurality of first gap members each composed of a non-magnetic body and arranged in respective ones of the plurality of gaps in the first core member.

### Advantageous Effects of Invention

According to the power conversion device in the present disclosure, influence by induction heating of a winding caused by leakage fluxes in a core gap portion in a reactor can be lessened and a coil can be reduced in size.

### BRIEF DESCRIPTION OF DRAWINGS

FIG. 1 is a circuit diagram showing a configuration of a power conversion device 1 in a first embodiment.

FIG. 2 is a schematic perspective view showing an appearance of power conversion device 1 in the first embodiment.

FIG. 3 is a cross-sectional view of a core 300 included in a reactor 100.

FIG. 4 is a winding diagram of reactor 100.

FIG. 5 is a partial cross-sectional view of a winding, with a portion around a gap member being shown as being enlarged.

FIG. 6 is a diagram showing magnetic fluxes at the time when a normal-mode current flows in reactor 100.

FIG. 7 is a diagram showing magnetic fluxes at the time when a common-mode current flows in reactor 100.

FIG. 8 is a circuit diagram showing a main circuit configuration of a power conversion device according to a second embodiment.

FIG. 9 is a diagram showing magnetic fluxes at the time when a normal-mode current flows in a reactor 103.

FIG. 10 is a diagram showing magnetic fluxes at the time when a common-mode current flows in reactor 103.

FIG. 11 is a circuit diagram showing a main circuit configuration of a power conversion device according to a third embodiment.

FIG. 12 is a winding diagram of a reactor 104.

FIG. 13 is a diagram showing magnetic fluxes at the time when a normal-mode current flows in reactor 104.

FIG. 14 is a diagram showing magnetic fluxes at the time when a common-mode current flows in reactor 104.

FIG. 15 is a cross-sectional view of a core 312 according to a fourth embodiment.

FIG. 16 is a cross-sectional view of a core 321 according to a fifth embodiment.

### DESCRIPTION OF EMBODIMENTS

An embodiment will be described in detail below with reference to the drawings. The same or corresponding elements in the drawings have the same reference characters allotted and description thereof will not be repeated in principles.

### First Embodiment

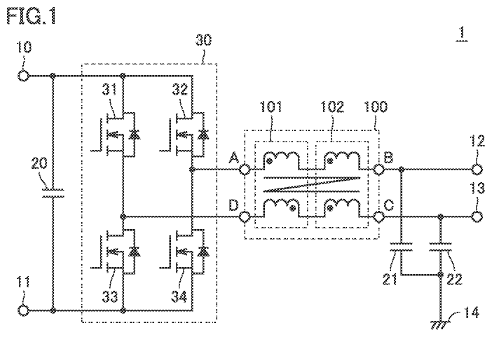

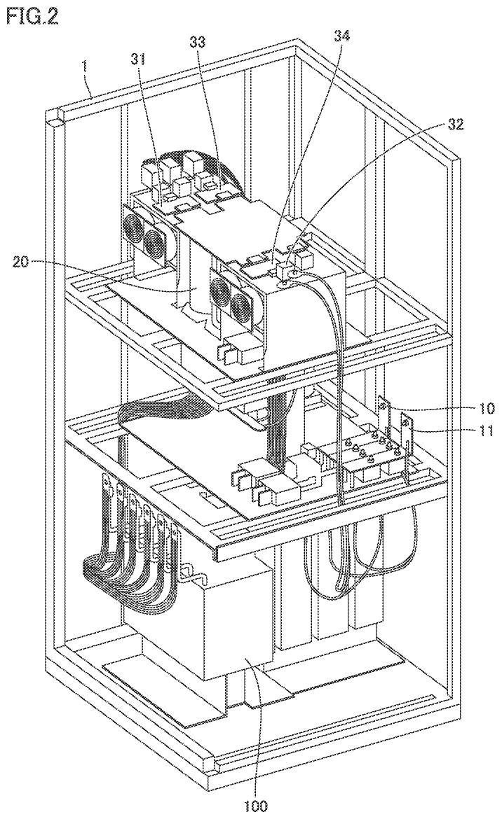

FIG. 1 is a circuit diagram showing a configuration of a power conversion device 1 in a first embodiment. FIG. 2 is a schematic perspective view showing an appearance of power conversion device 1 in the first embodiment. In other words, FIG. 2 shows a finished product based on the circuit diagram in FIG. 1, by assembly of members.

A reactor 100 mounted on power conversion device 1 in the first embodiment will be described with reference to FIGS. 1 and 2.

Power conversion device 1 includes input terminals 10 and 11, smoothing capacitors 20 to 22, a switching circuit 30, reactor 100, and output terminals 12 and 13.

Input terminals 10 to 11 receive a direct-current (DC) voltage. Smoothing capacitor 20 stabilizes the received DC voltage. Switching circuit 30 is composed of semiconductor elements 31 to 34. Switching circuit 30 converts the DC voltage by switching. Reactor 100 and smoothing capacitors 21 to 22 stabilize the converted DC voltage. Output terminals 12 to 13 supply the converted DC voltage to the outside of power conversion device 1 as a power supply voltage.

Reactor 100 performs a function to convert a voltage of input terminals 10 to 11 and to smoothen the voltage to output a DC current to output terminals 12 to 13. A normal-mode inductance 101 is required for smoothening.

Smoothing capacitors 21 and 22 may each have one end connected to a grounding terminal 14 in conformity with EMI regulations or safety standards.

In this case, a path through which a high-frequency current passes is provided from a terminal B and a terminal C of reactor 100 through smoothing capacitors 21 and 22 and grounding terminal 14 toward a grounding portion of input terminal 11 and a grounding portion of an input circuit preceding input terminals 10 and 11.

In order to restrict this high-frequency current, a common-mode inductance 102 is required in reactor 100.

Semiconductor elements 31 to 34 are switched at a frequency approximately from 50 Hz to 5 MHz. In order to avoid occurrence of a malfunction of a device to which an output is provided due to propagation of switching noise to output terminals 12 to 13 or a malfunction of peripherals due to radiation electromagnetic waves radiated over a space, common-mode inductance 102 is required in reactor 100.

Reactor 100 in the present embodiment includes both of normal-mode inductance 101 and common-mode inductance 102, and inductance values thereof can be set highly accurately and extensively.

Furthermore, influence by induction heating of a winding due to leakage fluxes in a core gap portion can be lessened and a coil can be reduced in size.

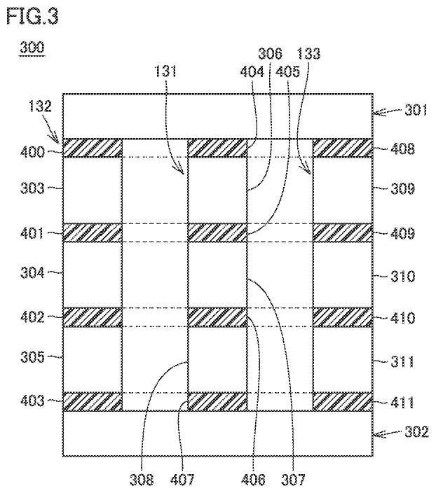

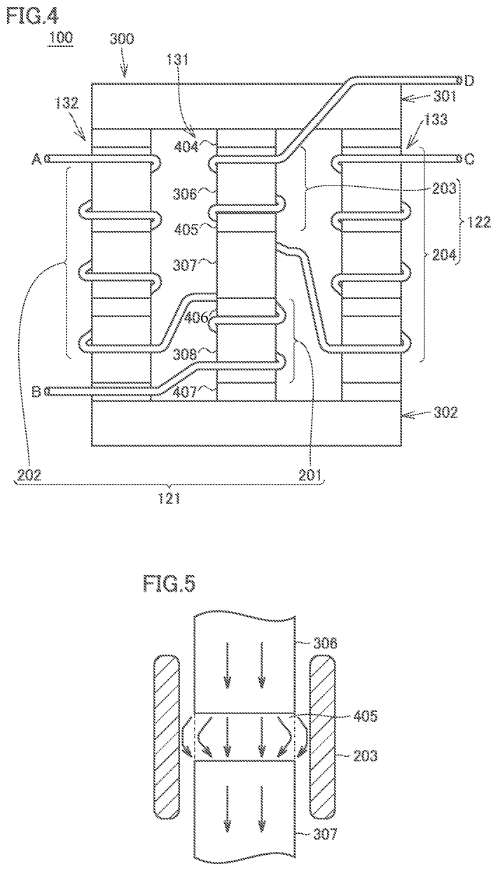

FIG. 3 is a cross-sectional view of a core 300 included in reactor 100. FIG. 4 is a winding diagram of reactor 100. A construction of reactor 100 will be described with reference to FIGS. 3 to 4.

Core 300 includes a first member 301, a second member 302, core pieces 303 to 311, and gap members 400 to 411 which are divided into small pieces.

First member 301, second member 302, and core pieces 303 to 311 are composed, for example, of a soft magnetic material such as a dust core made of pure iron, an Fe—Si alloy, an Fe—Si—Al alloy, an Ni—Fe alloy, or an Ni—Fe—Mo alloy, a ferrite core based on Mn—Zn or Ni—Zn, an amorphous core, or a nanocrystalline core. For insulation, a powdery resin or the like may be applied to each of first member 301, second member 302, and core pieces 303 to 311. In general, the dust core and the ferrite core are obtained by forming a powdery material with a press machine and thereafter subjecting the material to heat treatment. For the dust core and the ferrite core, a surface pressure applied to a pressed surface thereof should be constant, and as the core is larger in size, a press machine higher in pressing capability should be used. Since the formed material shrinks at the time of heat treatment, dimension accuracy becomes lower with increase in size of the core. First member 301, second member 302, and core pieces 303 to 311 shown in the first embodiment form a large-sized core 300 based on combination of cores divided into small pieces. Therefore, first member 301, second member 302, and core pieces 303 to 311 are readily manufactured, manufacturing cost can be reduced, variation in manufacturing is less, and quality is improved. Other exemplary materials may include an amorphous core and a nanocrystalline core. These cores are obtained by layering thin materials in a band shape and thereafter subjecting the materials to heat treatment. Since they also shrink at the time of heat treatment similarly to the dust core and the ferrite core, an effect the same as above is obtained by dividing them into small pieces.

Gap members 400 to 411 are composed of a non-magnetic body. For example, a resin such as polypropylene (PP), ABS, polyethylene terephthalate (PET), polycarbonate (PC), fluorine, phenol, melamine, polyurethane, epoxy, or silicon, kraft pulp, aramid, fibers, or insulating paper can be employed as a material for gap members 400 to 411.

For example, the dust core is relatively low in relative permeability which is approximately from 26 to 150. Therefore, a length of a core gap may be set to a length approximately from 0.1 to 20 mm, and a thickness of gap members 400 to 411 may be determined in conformity with the length of the core gap. For example, the ferrite core is relatively high in relative permeability which is from 1500 to 4000. Therefore, the length of the core gap in the case of the ferrite core is set approximately to 0.1 to 40 mm, which is longer than in the case of the dust core. As the number of divided core pieces 303 to 311 is larger and the number of core gaps is larger, the length of the core gap per location is shorter. As the core gap is shorter, fewer magnetic fluxes leak. Therefore, eddy current loss in windings 201 to 204 caused by linkage of magnetic fluxes that leak from the core gap with windings 201 to 204 can be reduced.

Gap members 400 to 411 may be fixed by application of an adhesive to at least one or all of surfaces thereof in contact with first member 301, second member 302, and core pieces 303 to 311. Alternatively, an adhesive may be applied to at least one or all of surfaces of gap members 400 to 411 to bond the gap members to first member 301, second member 302, and core pieces 303 to 311.

A construction of windings 201 to 204 included in reactor 100 will be described with reference to FIG. 4. Windings 201 to 204 are wound around core 300 described with reference to FIG. 3. For a flow of a current, windings 201 to 204 are composed of copper or aluminum low in electrical resistivity. In order to prevent short-circuiting to an adjacent winding, windings 201 to 204 are preferably made from a conductive wire with an insulating coating or from a conductive wire around which insulating paper is wrapped. For prevention of short-circuiting between adjacent coils, a coating or a cover may have a thickness approximately from 0.001 to 2 mm. These windings 201 to 204 are wound to cover at least one gap member.

FIG. 5 is a partial cross-sectional view of a winding, with a portion around a gap member being shown as being enlarged. There are a plurality of gap members.

Since a length of a core gap per location is short, fewer magnetic fluxes leak from the core gap portion. Therefore, eddy current loss in windings 201 to 204 caused by linkage of magnetic fluxes that leak from the core gap with windings 201 to 204 can be reduced and portions where a temperature increases are distributed. Therefore, the winding can be reduced in size.

When a winding is arranged to cover the core gap as shown in FIG. 5, magnetic fluxes flow along a surface of the winding made of a conductor. Therefore, magnetic fluxes that leak from the core gap can be shielded by the winding, and thus leakage fluxes to the outside of reactor 100 can be reduced.

How to wind a winding will be described with reference again to FIGS. 3 and 4.

Windings 201 and 203 are wound around core pieces 306 to 308 that form a first leg portion 131 (a middle leg) of core 300 from a side of first member 301 toward second member 302. At this time, windings 201 and 203 are wound clockwise when first leg portion 131 is viewed from an upper surface of the reactor, that is, from the side of first member 301.

Winding 202 is wound around core pieces 303 to 305 that form a second leg portion 132 (a left leg) of core 300 from the side of first member 301 toward second member 302. At this time, winding 202 is wound counterclockwise when first leg portion 131 is viewed from the upper surface of the reactor, that is, from the side of first member 301.

Winding 204 is wound around core pieces 309 to 311 that form a third leg portion 133 (a right leg) of core 300 from the side of first member 301 toward second member 302. At this time, winding 204 is wound clockwise when first leg portion 131 is viewed from the upper surface of the reactor, that is, from the side of first member 301.

One end of winding 202 and one end of winding 201 are directly connected to each other. One end of winding 204 and one end of winding 203 are also directly connected to each other.

Preferably, winding 202 and winding 204 are wound the same number of turns. The same number of turns is preferred because a density of magnetic fluxes that cancel each other, which will be described later, is the same.

Winding 201 and winding 203 are wound the same number of turns. The same number of turns is preferred because a density of magnetic fluxes that cancel each other, which will be described later, is the same.

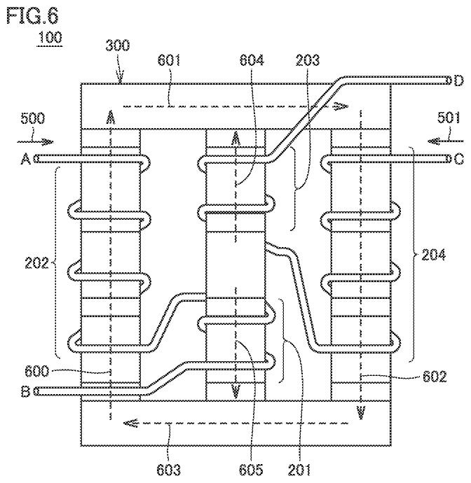

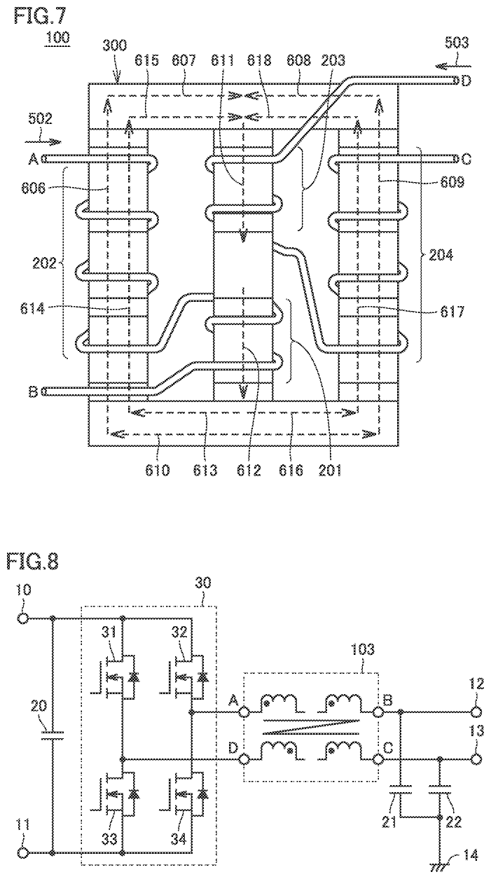

FIG. 6 is a diagram showing magnetic fluxes at the time when a normal-mode current flows in reactor 100. FIG. 7 is a diagram showing magnetic fluxes at the time when a common-mode current flows in reactor 100. A behavior of a magnetic circuit in each current mode will be described with reference to FIGS. 6 to 7.

Referring to FIG. 1 again, reactor 100 has terminals A and D connected to switching circuit 30. Reactor 100 has a terminal B connected to smoothing capacitor 21 and output terminal 12. Reactor 100 has a terminal C connected to smoothing capacitor 22 and output terminal 13. With such connection relation, in an example where a current flows from terminal A toward terminal B, the current that flows from terminal C toward terminal D is a normal-mode current, and the current that flows from terminal D toward terminal C is a common-mode current.

A behavior of the magnetic circuit at the time when the normal-mode current flows will be described with reference to FIG. 6. In the case of the normal-mode current, a current 500 flows from terminal A of winding 202 and a current 501 flows from terminal C of winding 204. At this time, magnetic fluxes 600 to 605 are produced under the Ampere law.

So long as winding 203 and winding 201 are equal to each other in number of turns, magnetic flux 604 produced by winding 203 and magnetic flux 605 produced by winding 201 have magnetic flux densities equal to each other in magnitude and reverse to each other in orientation. Since magnetic flux 604 and magnetic flux 605 pass through the same core cross-section, they cancel each other. Therefore, first leg portion 131 and windings 203 and 201 do not contribute as the normal-mode inductance of reactor 100.

Even when winding 203 and winding 201 are not equal to each other in number of turns, magnetic fluxes produced thereby cancel each other. Therefore, first leg portion 131 of the core and winding 203 and winding 201 can contribute less to the normal-mode inductance.

The normal-mode inductance at this time is determined by magnetic fluxes 600 to 603, the number of turns of each of winding 202 and winding 204, and a thickness of each of gap members 400 to 403 and 408 to 411.

A behavior of the magnetic circuit at the time when the common-mode current flows will be described with reference to FIG. 7. In the case of the common-mode current, a current 502 flows from terminal A of winding 202 and a current 503 flows from terminal D of winding 203. At this time, magnetic fluxes 606 to 618 are produced under the Ampere law.

Among these magnetic fluxes, magnetic fluxes 606 to 607 produced by winding 202 and magnetic fluxes 608 to 609 produced by winding 204 are equal to each other in density so long as winding 202 and winding 204 are equal to each other in number of turns. Since these magnetic fluxes pass through the same core cross-section in second leg portion 132 and third leg portion 133, they cancel each other. Therefore, winding 202 and winding 204 do not contribute as the common-mode inductance.

Even when winding 202 and winding 204 are not equal to each other in number of turns, magnetic fluxes produced thereby cancel each other. Therefore, winding 202 and winding 204 can contribute less to the common-mode inductance.

Therefore, an inductance which is combination of the inductance through a path of magnetic fluxes 614→615→611→612→613 produced by winding 201 and the inductance through a path of magnetic fluxes 617→618→611→612→616 produced by winding 203 serves as the common-mode inductance.

The common-mode inductance determined by windings 201 and 203 can be higher than the common-mode inductance produced by winding 202 and winding 204, so that the common-mode inductance can highly accurately be provided by windings 201 and 203.

Therefore, an approximate value of the common-mode inductance at this time is determined by magnetic fluxes 611 to 618, the number of turns of each of winding 201 and winding 203, and the thickness of each of gap members 400 to 411.

In general, a value of the normal-mode inductance and a value of the common-mode inductance required in the power conversion device are different from each other.

For example, when the normal-mode inductance is lower than the common-mode inductance, the thickness of each of gap members 400 to 403 in second leg portion 132 and gap members 408 to 411 in third leg portion 133 is made smaller and the thickness of gap members 404 to 407 in first leg portion 131 is made larger. The normal-mode inductance and the common-mode inductance can thus be brought closer to the respective required normal-mode inductance and common-mode inductance.

In contrast, when the normal-mode inductance is higher than the common-mode inductance, the thickness of each of gap members 400 to 403 and 408 to 411 is made larger and the thickness of gap members 404 to 407 is made smaller. The normal-mode inductance and the common-mode inductance can thus be brought closer to similarly required values of respective inductances.

As set forth above, the desired normal-mode inductance and the desired common-mode inductance can be realized with single reactor 100 without the need for mounting of two types which are a normal-mode reactor and a common-mode reactor, and reduction in size of the power conversion device can be expected.

For the normal-mode inductance, by adjusting the thickness of gap members 400 to 403 and 408 to 411 in addition to adjustment of the number of turns of winding 202 and winding 204 arranged in the left leg and the right leg of the core, the inductance can be provided highly accurately and extensively.

For the common-mode inductance, by adjusting the number of turns of each of winding 201 and winding 203 and the thickness of gap members 404 to 407 in the middle leg of the core after adjustment of the normal-mode inductance, the inductance can be provided highly accurately and extensively.

The inductance in each mode can thus be adjusted and reactors of various specifications can be realized.

In adjustment to a low inductance, the thickness of the gap member is made smaller and the number of gap members is increased, so that the core gap length per location is shorter and the inductance can be lowered as in a general theoretical equation.

Furthermore, by arranging core gaps as being distributed at a plurality of locations, the core gap length per location is shorter, so that influence by induction heating of the winding caused by leakage fluxes in the core can be lessened and reduction in size of the winding owing to lower loss can be achieved.

Though the construction in which a plurality of gap members are included is described in the present embodiment, the desired normal-mode inductance and the desired common-mode inductance can be provided also by adjustment only of a winding method and the number of turns, without the use of the gap member.

### Second Embodiment

FIG. 8 is a circuit diagram showing a main circuit configuration of a power conversion device according to a second embodiment. The power conversion device according to the second embodiment includes a reactor 103 instead of reactor 100 in the configuration of the power conversion device in the first embodiment. Since each component of the circuit having the same reference numeral allotted is the same as in the first embodiment, description thereof will not be repeated.

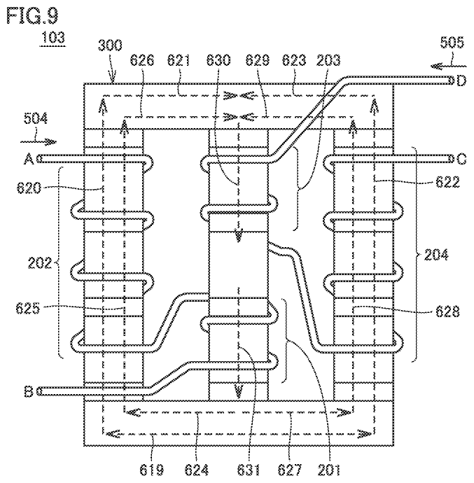

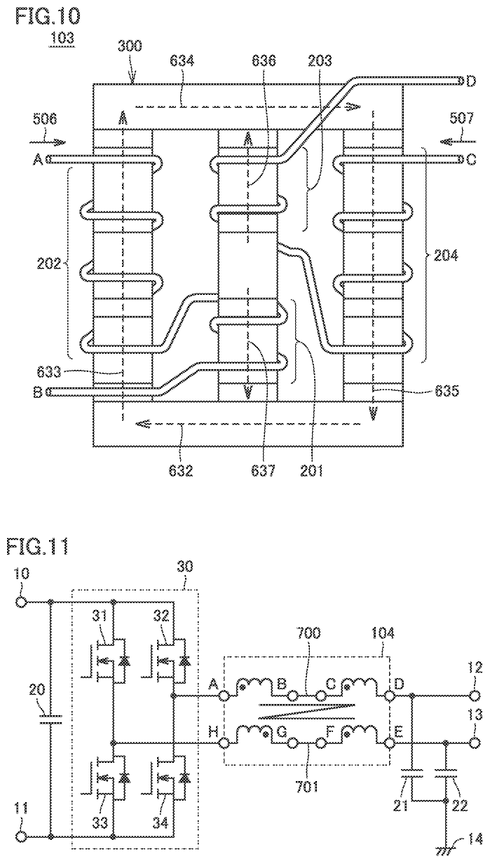

FIG. 9 is a diagram showing magnetic fluxes at the time when a normal-mode current flows in reactor 103. FIG. 10 is a diagram showing magnetic fluxes at the time when a common-mode current flows in reactor 103. Reactor 103 according to the second embodiment will be described with reference to FIGS. 9 and 10.

Reactor 103 is similar to reactor 100 described in the first embodiment in the construction of core 300 and how windings 201 to 204 are wound. Reactor 103 is different from reactor 100 in the first embodiment in connection to switching circuit 30 and the output terminals as below.

As shown in FIG. 8, reactor 103 has terminals A and D connected to switching circuit 30. Reactor 103 has a terminal B connected to smoothing capacitor 21 and output terminal 12. Reactor 103 has a terminal C connected to smoothing capacitor 22 and output terminal 13. With such connection relation, in an example where a current flows from terminal A toward terminal B, the current that flows from terminal C toward terminal D is a normal-mode current, and the current that flows from terminal D toward terminal C is a common-mode current. A behavior of the magnetic circuit in each current mode will be described with reference to FIGS. 9 and 10.

A behavior of the magnetic circuit at the time when the normal-mode current flows will be described with reference to FIG. 9. In the case of the normal-mode current, a current 504 flows from terminal A of winding 202 and a current 505 flows from terminal D of winding 203. At this time, magnetic fluxes 619 to 631 are produced under the Ampere law.

Among these magnetic fluxes, magnetic fluxes 619 to 621 produced by winding 202 and magnetic fluxes 622 to 623 and 627 produced by winding 204 have magnetic flux densities equal to each other in magnitude and reverse to each other in orientation so long as winding 202 and winding 204 are equal to each other in number of turns. Since these magnetic fluxes pass through the same core cross-section in second leg portion 132 and third leg portion 133, they cancel each other and they do not contribute as the normal-mode inductance.

Even when winding 202 and winding 204 are not equal to each other in number of turns, magnetic fluxes produced thereby cancel each other. Therefore, winding 202 and winding 204 can contribute less to the normal-mode inductance.

Therefore, an inductance which is combination of the inductance through a path of magnetic fluxes 624→625→626→630→631 produced by winding 201 and the inductance through a path of magnetic fluxes 627→628→629→630→631 produced by winding 203 serves as the normal-mode inductance.

The common-mode inductance determined by windings 201 and 203 can be higher than the common-mode inductance produced by winding 202 and winding 204, so that the common-mode inductance can highly accurately be provided by windings 201 and 203.

Therefore, an approximate value of the normal-mode inductance at this time is determined by magnetic fluxes 624 to 631, the number of turns of each of windings 201 and 203, and the thickness of each of gap members 400 to 411.

A behavior of the magnetic circuit at the time when the common-mode current flows will be described with reference to FIG. 10. In the case of the common-mode current, a current 506 flows from terminal A of winding 202 and a current 507 flows from terminal C of winding 204. At this time, magnetic fluxes 632 to 637 are produced under the Ampere law.

Magnetic flux 636 produced by winding 203 and magnetic flux 637 produced by winding 201 have magnetic flux densities equal to each other in magnitude and reverse to each other in orientation. Since magnetic flux 636 and magnetic flux 637 pass through the same core cross-section, they cancel each other. Therefore, first leg portion 131 of the core and windings 203 and 201 do not contribute as the normal-mode inductance of reactor 103.

The normal-mode inductance at this time is determined by magnetic fluxes 632 to 635, the number of turns of each of windings 202 and 204, and the thickness of gap members 400 to 403 and 408 to 411.

An effect the same as in the first embodiment can be obtained even in a construction where a component to which a terminal through which a current flows in and out is connected is interchanged.

In the first embodiment, approximately 20% of the normal-mode inductance is superimposed on the common-mode inductance, whereas in the second embodiment, approximately 20% of the common-mode inductance is superimposed on the normal-mode inductance.

Depending on an applied circuit and accuracy necessary for an inductance, based on a method of connecting a winding, the number of turns, and a thickness and the number of gap members, the inductance can be provided highly accurately and extensively.

### Third Embodiment

FIG. 11 is a circuit diagram showing a main circuit configuration of a power conversion device according to a third embodiment. The power conversion device according to the third embodiment includes a reactor 104 instead of reactor 100 in the configuration of the power conversion device in the first embodiment. Since each component of the circuit having the same reference numeral allotted is the same as in the first embodiment, description thereof will not be repeated.

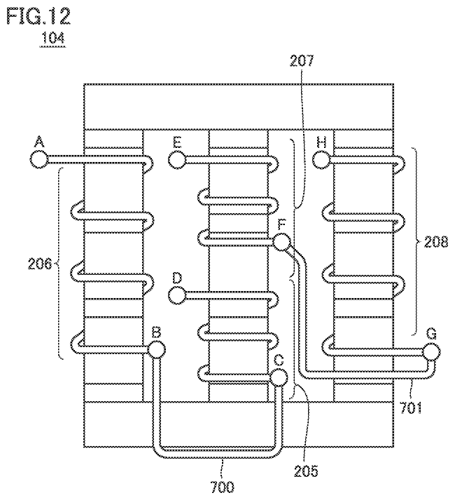

FIG. 12 is a winding diagram of reactor 104. Reactor 104 according to the third embodiment will be described with reference to FIG. 12. Since a construction of core 300 is the same as in the first and second embodiments, description thereof will not be repeated.

Windings 205 to 208 are wound from the side of first member 301 toward second member 302. At this time, windings 205 to 208 are all wound counterclockwise when first leg portion 131 is viewed from above the reactor, that is, from the side of first member 301.

Winding 206 and winding 208 are wound as being equal to each other in number of turns. Similarly, winding 205 and winding 207 are wound as being equal to each other in number of turns.

A terminal B of winding 206 and a terminal C of winding 205 are worked such that a conductor 700 such as copper or aluminum can be connected thereto. A terminal F of winding 207 and a terminal G of winding 208 are worked such that a conductor 701 such as copper or aluminum can be connected thereto.

Normally, a large winding is formed by manually winding a linear conductor around a model. Alternatively, in an example where an automatic machine or a semi-automatic machine is used as well, a large winding is similarly formed by winding a linear conductor around a model.

As in the present embodiment, so long as the number of windings and a direction of winding are the same, windings 206 and 208 are in the same winding shape. In addition, windings 205 and 207 are in the same winding shape. Therefore, since only a small number of types of components are necessary, manufacturing can be low in cost and erroneous assembly can be prevented, so that an effect such as improvement in quality is also obtained.

After windings 205 to 208 are incorporated into core 300, conductors 700 to 701 are connected to windings 205 to 208 to form reactor 104.

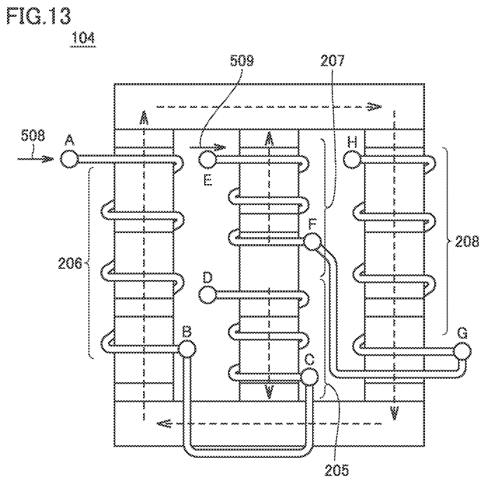

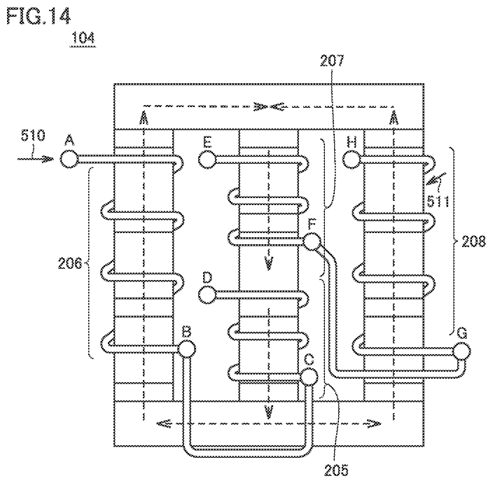

FIG. 13 is a diagram showing magnetic fluxes at the time when a normal-mode current flows in reactor 104. A behavior of the magnetic circuit at the when the normal-mode current flows will be described with reference to FIG. 13.

In the case of the normal-mode current, a current 508 flows from terminal A of winding 206 and a current 509 flows from a terminal E of winding 207. Since a state of production of magnetic fluxes in core 300 is similar to a state of production of magnetic fluxes in the case of the normal-mode current in the first embodiment described with reference to FIG. 6, description thereof will not be repeated.

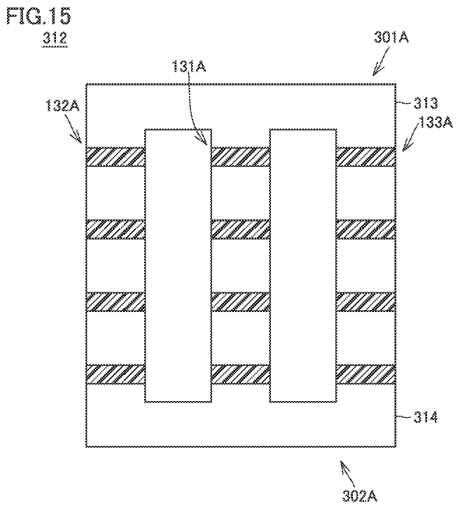

FIG. 14 is a diagram showing magnetic fluxes at the time when a common-mode current flows in reactor 104. A behavior of the magnetic circuit at the time when the common-mode current flows will be described with reference to FIG. 14.

In the case of the common-mode current, a current 510 flows from terminal A of winding 206 and a current 511 flows from a terminal H of winding 208. Since a state of production of magnetic fluxes in core 300 is similar to a state of production of magnetic fluxes in the case of the common-mode current in the first embodiment described with reference to FIG. 7, description thereof will not be repeated.

An effect as in the first and second embodiments can be obtained by setting a winding direction of a winding and the number of turns to be the same to facilitate manufacturing of the winding while connecting terminals of the windings through conductors 700 and 701 as in the present embodiment.

### Fourth Embodiment

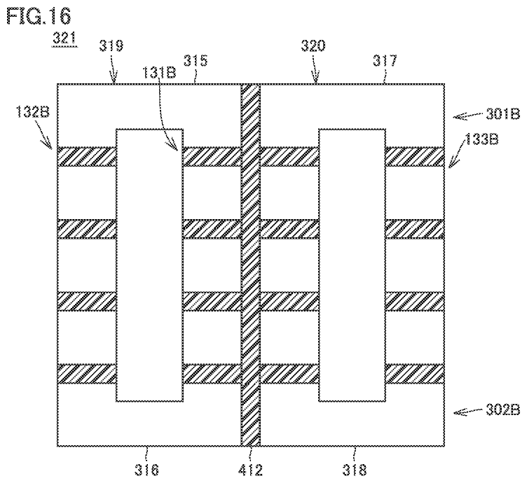

FIG. 15 is a cross-sectional view of a core 312 according to a fourth embodiment. Core 312 includes a first member 301A and a second member 302A arranged at a distance from each other and a first leg portion 131A, a second leg portion 132A, and a third leg portion 133A each connecting first member 301A and second member 302A to each other.

First member 301A and second member 302A of core 312 include core pieces 313 and 314 having a cross-section in an E shape, respectively.

Core pieces 313 to 314 each have the cross-section in the E shape. Since a core gap is not provided in a portion where a magnetic flux is bent at 90° in a construction of core 312 shown in FIG. 15, leakage fluxes are reduced. A reactor is formed by winding the windings in the first to third embodiments around core 312. Since leakage fluxes that leak from the core gap are reduced, eddy current loss in the winding caused by linkage of the leakage fluxes with the winding can be reduced and the winding can be reduced in size.

### Fifth Embodiment

FIG. 16 is a cross-sectional view of a core 321 according to a fifth embodiment. Core 321 includes a first member 301B and a second member 302B arranged at a distance from each other and a first leg portion 131B, a second leg portion 132B, and a third leg portion 133B each connecting first member 301B and second member 302B to each other.

First member 301B of core 321 includes two core pieces 315 and 317 and second member 302B includes two core pieces 316 and 318. Core pieces 315 to 318 each have a cross-section in a U shape.

Core piece 315 and core piece 316 are arranged as being opposed to each other to form a hollow and rectangular core 319. Core piece 317 and core piece 318 are arranged as being opposed to each other to form a hollow and rectangular core 320. A gap member 412 is inserted between core 319 and core 320 to form core 321.

Core pieces 315 to 318 each having the cross-section in the U shape can be smaller in size and more readily be manufactured than first members 301 and 301A and second members 302 and 302A employed in the first to fourth embodiments. Thus, manufacturing cost can further be reduced, variation in manufacturing is less, and quality is improved.

According to each embodiment herein, the power conversion device incorporating a reactor the normal-mode inductance and the common-mode inductance of which can be provided highly accurately and extensively based on the thickness of gap members 400 to 411 inserted among first member 301, second member 302, and core pieces 303 to 311 can be provided.

In manufacturing of core pieces, a core is divided into small pieces. Therefore, influence by a pressing pressure in manufacturing or shrinkage after heat treatment can be lessened, manufacturing of divided cores is facilitated, manufacturing cost can be reduced, variation in manufacturing is less, and quality is improved.

Furthermore, the number of locations of core gaps can be increased, the length of each core gap can be shorter, eddy current loss in the winding due to magnetic fluxes that leak from the core gap can be reduced, and the winding can be reduced in size.

### SUMMARY

The first to fifth embodiments are summarized with reference again to the drawings.

As shown in FIG. 4, the power conversion device in the present disclosure includes reactor 100 including core 300, first conductive member 121, and second conductive member 122. Core 300 includes first member 301 and second member 302 arranged at a distance from each other and first leg portion 131, second leg portion 132, and third leg portion 133 each connecting first member 301 and second member 302 to each other. First leg portion 131 is arranged between second leg portion 132 and third leg portion 133. First conductive member 121 includes first winding 201 wound around first leg portion 131 and second winding 202 connected in series to first winding 201 and wound around second leg portion 132. Second conductive member 122 includes third winding 203 wound around the first leg portion and fourth winding 204 connected in series to third winding 203 and wound around third leg portion 133. First leg portion 131 includes the first core member composed of a soft magnetic material, provided with a plurality of gaps, and constituted of core pieces 306, 307, and 308 and a plurality of first gap members 404, 405, 406, and 407 each composed of a non-magnetic body and arranged in respective ones of the plurality of gaps in the first core member.

As set forth above, the core gap length per location is shorter by arrangement of core gaps at a plurality of locations in one leg portion of the core. Thus, influence by induction heating of the winding due to leakage fluxes in the core can be lessened and reduction in size of the winding owing to lower loss can be achieved.

As shown in FIG. 3, preferably, second leg portion 132 includes the second core member composed of a soft magnetic material, provided with a plurality of gaps, and constituted of core pieces 303, 304, and 305 and a plurality of second gap members 400, 401, 402, and 403 each composed of a non-magnetic body and arranged in respective ones of the plurality of gaps in the second core member. The third leg portion includes the third core member composed of a soft magnetic material, provided with a plurality of gaps, and constituted of core pieces 309, 310, and 311 and a plurality of third gap members 408, 409, 410, and 411 each composed of a non-magnetic body and arranged in respective ones of the plurality of gaps in the third core member.

By constructing the reactor as above, a single reactor can highly accurately and extensively provide a value of the common-mode inductance and a value of the normal-mode inductance. Therefore, it is not necessary to mount two types of reactors which are a normal-mode reactor and a common-mode reactor, and reduction in size of the power conversion device can be expected.

As shown in FIG. 5, preferably, at least a part of first winding 201 and third winding 203 is wound to cover at least one of the plurality of first gap members 404, 405, 406, and 407.

Magnetic fluxes that leak from the core gap can thus be shielded by the winding, and leakage fluxes to the outside of the reactor can be reduced.

As shown in FIG. 6, preferably, first winding 201 and third winding 203 are each wound such that magnetic flux 605 produced by first winding 201 and magnetic flux 604 produced by third winding 203 cancel each other when currents 500 and 501 in the normal mode flow through first conductive member 121 and second conductive member 122.

Stated differently, first winding 201 and third winding 203 are each wound such that an orientation of magnetic flux 605 produced by first winding 201 and an orientation of magnetic flux 604 produced by third winding 203 are reverse to each other when normal-mode currents 500 and 501 flow through first conductive member 121 and second conductive member 122.

Stated further differently, first winding 201 and third winding 203 are each wound such that magnetic flux 605 produced by first winding 201 and magnetic flux 604 produced by third winding 203 are in orientations to cancel each other when normal-mode currents 500 and 501 flow through first conductive member 121 and second conductive member 122.

As shown in FIGS. 4 and 6, preferably, the number of turns of first winding 201 wound around first leg portion 131 is the same as the number of turns of third winding 203 wound around first leg portion 131. Though the numbers of turns are preferably the same, they may slightly be different.

According to such a construction, the normal-mode inductance can be determined by the number of turns of second winding 202 and fourth winding 204.

As shown in FIG. 15, preferably, first member 301A and second member 302A include core pieces 313 and 314 having the cross-section in the E shape, respectively.

According to such a construction, there is no core gap in a corner portion. Therefore, leakage fluxes that leak from the core gap are reduced, eddy current loss in the winding caused by linkage of the leakage fluxes with the winding can be reduced, and the winding can be reduced in size.

As shown in FIG. 16, preferably, first member 301B includes first core piece 315 having the cross-section in the U shape and second core piece 317 having the cross-section in the U shape, and second member 302B includes first core piece 316 having the cross-section in the U shape and second core piece 318 having the cross-section in the U shape.

The core piece thus has the cross-section in the U shape, so that reduction in size can be achieved, and furthermore, manufacturing is facilitated, manufacturing cost can be reduced, variation in manufacturing is less, and quality is improved.

Each embodiment disclosed herein is also intended to be carried out as being combined as appropriate unless the combination is inconsistent. It should be understood that the embodiments disclosed herein are illustrative and non-restrictive in every respect. The scope of the present disclosure is defined by the terms of the claims rather than the description of the embodiments above and is intended to include any modifications within the scope and meaning equivalent to the terms of the claims.

For example, the number of core pieces to constitute core 300, 312, 315, or 321 and the number of gap members which are not as shown in the embodiments herein are intended to be within the scope of claims.

### REFERENCE SIGNS LIST

1 power conversion device; 10, 11 input terminal; 12, 13 output terminal; 14 grounding terminal; 20, 21, 22 smoothing capacitor; 30 switching circuit; 31 to 34 semiconductor element; 100, 103, 104 reactor; 101 normal-mode inductance; 102 common-mode inductance; 121 first conductive member; 122 second conductive member; 131, 131A, 131B first leg portion; 132, 132A, 132B second leg portion; 133, 133A, 133B third leg portion; 201, 202, 203, 204, 205, 206, 207, 208 winding; 300, 312, 319, 320, 321 core; 301, 301A, 301B first member; 302, 302A, 302B second member; 303 to 311, 313 to 318 core piece; 400 to 412 gap member; 500 to 511 current; 600 to 637 magnetic flux; 700, 701 conductor; A, B, C, D, E, F, G, H terminal

1. A power conversion device comprising:
a core;
a first conductive member; and
a second conductive member, wherein
the core includes
a first member and a second member arranged at a distance from each other, and
a first leg portion, a second leg portion, and a third leg portion each connecting the first member and the second member to each other,
the first leg portion is arranged between the second leg portion and the third leg portion,
the first conductive member includes
a first winding wound around the first leg portion, and
a second winding connected in series to the first winding and wound around the second leg portion,
the second conductive member includes
a third winding wound around the first leg portion, and
a fourth winding connected in series to the third winding and wound around the third leg portion, and
the first leg portion includes
a first core member composed of a soft magnetic material and provided with a plurality of gaps, and
a plurality of first gap members each composed of a non-magnetic body and arranged in respective ones of the plurality of gaps in the first core member.

2. The power conversion device according to claim 1, wherein
the second leg portion includes
a second core member composed of a soft magnetic material and provided with a plurality of gaps, and
a plurality of second gap members each composed of a non-magnetic body and arranged in respective ones of the plurality of gaps in the second core member, and
the third leg portion includes
a third core member composed of a soft magnetic material and provided with a plurality of gaps, and
a plurality of third gap members each composed of a non-magnetic body and arranged in respective ones of the plurality of gaps in the third core member.

3. The power conversion device according to claim 1, wherein
at least a part of the first winding and the third winding is wound to cover at least one of the plurality of first gap members.

4. The power conversion device according to claim 1, wherein
the first winding and the third winding are each wound such that a magnetic flux generated by the first winding and a magnetic flux generated by the third winding cancel each other when a normal-mode current flows through the first conductive member and the second conductive member.

5. The power conversion device according to claim 1, wherein
each of the first member and the second member includes a core piece having a cross-section in an E shape.

6. The power conversion device according to claim 1, wherein
each of the first member and the second member includes a first core piece having a cross-section in a U shape and a second core piece having a cross-section in a U shape.

7. The power conversion device according to claim 1, wherein
the first winding and the third winding are each wound such that an orientation of a magnetic flux generated by the first winding and an orientation of a magnetic flux generated by the third winding are reverse to each other when a normal-mode current flows through the first conductive member and the second conductive member.

8. The power conversion device according to claim 1, wherein
the first winding and the third winding are each wound such that a magnetic flux generated by the first winding and a magnetic flux generated by the third winding are in orientations to cancel each other when a normal-mode current flows through the first conductive member and the second conductive member.

9. The power conversion device according to claim 1, wherein
the number of turns of the first winding wound around the first leg portion is equal to the number of turns of the third winding wound around the first leg portion.

10. A power conversion device comprising:
a core;
a first conductive member; and
a second conductive member, wherein
the core includes
a first member and a second member arranged at a distance from each other, and
a first leg portion, a second leg portion, and a third leg portion each connecting the first member and the second member to each other,
the first leg portion is arranged between the second leg portion and the third leg portion,
the first conductive member includes
a first winding wound around the first leg portion, and
a second winding connected in series to the first winding and wound around the second leg portion,
the second conductive member includes
a third winding wound around the first leg portion, and
a fourth winding connected in series to the third winding and wound around the third leg portion, and
each of the second and third leg portions includes
a first core member composed of a soft magnetic material and provided with a plurality of gaps, and
a plurality of first gap members each composed of a non-magnetic body and arranged in respective ones of the plurality of gaps in the first core member.

11. The power conversion device according to claim 1, wherein
the core is composed of a dust core, and
a length of each of the plurality of gaps is set to a length from 0.1 to 20 mm.

12. The power conversion device according to claim 1, wherein
the core is composed of a ferrite core, and
a length of each of the plurality of gaps is set to a length from 0.1 to 40 mm.

13. The power conversion device according to claim 1, wherein
a thickness of each of the plurality of the first gap members in the first leg portion is different from a thickness of each of the plurality of the second gap members in the second leg and a thickness of each of the plurality of the third gap members in the third leg.

14. The power conversion device according to claim 13, wherein
the thickness of each of the plurality of first gap members is thicker than the thickness of each of the plurality of second and third gap members.

15. The power conversion device according to claim 13, wherein
the thickness of each of the plurality of second and third gap members is thicker than the thickness of each of the plurality of first gap members.
